(19) United States
(12) Patent Application Publication
(10) Pub. No.: US 2020/0327890 A1
(43) Pub. Date: Oct. 15, 2020

(54) INFORMATION PROCESSING DEVICE AND INFORMATION PROCESSING METHOD

(71) Applicant: SONY CORPORATION, TOKYO (JP)

(72) Inventor: MARI SAITO, KANAGAWA (JP)

(21) Appl. No.: 16/765,438

(22) PCT Filed: Nov. 14, 2018
(86) PCT No.: PCT/JP2018/042058

§ 371 Date: May 19, 2020

(30) Foreign Application Priority Data
Nov. 28, 2017 (JP) 2017-227377

(51) Int. Cl. G10L 15/22; G10L 15/10; G10L 15/07; G10L 15/18

(52) U.S. Cl. CPC G10L 15/22; G10L 15/10; G10L 2015/223; G10L 15/1815; G10L 15/07

(57) ABSTRACT

The present technology relates to an information processing device and an information processing method for enabling an appropriate response at the time of occurrence of an interruptive utterance. An information processing device is provided, which includes a control unit that controls presentation of a response to a first utterance by a user on the basis of content of a second utterance temporally later than the first utterance. Therefore, a system can make an appropriate response at the time of occurrence of an interruptive utterance to the utterance of the user. The present technology can be applied to, for example, a voice interaction system.

### TECHNICAL FIELD

The present technology relates to an information processing device and an information processing method, and more particularly to an information processing device and an information processing method for enabling an appropriate response at the time of occurrence of an interruptive utterance.

### BACKGROUND ART

In recent years, voice interaction systems that respond to users' utterances have begun to be used in various fields. A voice interaction system is required not only to recognize a voice of a user's utterance but also to estimate an intention of the user's utterance, and to make an appropriate response.

Furthermore, in a case where a user has made a certain utterance, a scene in which another utterance interrupts the interaction is assumed. The system side needs to perform an appropriate operation for such an interruptive utterance.

For example, Patent Document 1 discloses that, when a plurality of interruptions of two or more pieces of interruptive information occurs, interruptive information having a larger value in priority is preferentially output according to priorities set to the two or more pieces of interruptive information.

Furthermore, for example, Patent Document 2 discloses that user's motion information is recognized from input data of a voice signal, a head movement, a line-of-sight direction, and a facial expression, and time information, and which of a computer and the user has the right to utter is determined on the basis of the recognition result, and a response from the computer side is generated according to where the right to utter lies.

### CITATION LIST

### Patent Document

Patent Document 1: Japanese Patent Application Laid-Open No. 2013-29977
Patent Document 2: Japanese Patent Application Laid-Open No. 9-269889

### SUMMARY OF THE INVENTION

### Problems to be Solved by the Invention

However, there is a possibility that an appropriate response cannot be made on the system side at the time of occurrence of an interruptive utterance, depending on an interactive situation between the user and the system, in the determination of the priority or the right to utter for the interruptive information disclosed in the above-described Patent Documents 1 and 2.

The present technology has been made in view of such a situation, and enables an appropriate response at the time of occurrence of an interruptive utterance.

### Solutions to Problems

An information processing device according to one aspect of the present technology is an information processing device including a control unit configured to control presentation of a response to a first utterance by a user on the basis of content of a second utterance that is temporally later than the first utterance.

An information processing method according to one aspect of the present technology is an information processing method of an information processing device, the information processing method including, by the information processing device, controlling presentation of a response to a first utterance by a user on the basis of content of a second utterance that is temporally later than the first utterance.

In the information processing device and the information processing method according to the one aspect of the present technology, presentation of a response to a first utterance by a user is controlled on the basis of content of a second utterance that is temporally later than the first utterance.

The information processing device according to one aspect of the present technology may be an independent device or may be internal blocks constituting one device.

### Effects of the Invention

According to one aspect of the present technology, an appropriate response can be made at the time of occurrence of an interruptive utterance.

Note that the effects described here are not necessarily limited, and any of effects described in the present disclosure may be exhibited.

### BRIEF DESCRIPTION OF DRAWINGS

FIG. 1 is a block diagram illustrating an example of a configuration of a voice interaction system to which the present technology is applied.

FIG. 2 is a block diagram illustrating an example of a functional configuration of the voice interaction system.

FIG. 3 is a diagram illustrating a first example of presentation of a result of execution.

FIG. 4 is a diagram illustrating a second example of presentation of a result of execution.

FIG. 5 is a diagram illustrating a third example of presentation of a result of execution.

FIG. 6 is a diagram illustrating a fourth example of presentation of a result of execution.

FIG. 7 is a diagram illustrating a fifth example of presentation of a result of execution.

FIG. 8 is a diagram illustrating a sixth example of presentation of a result of execution.

FIG. 9 is a flowchart for describing a flow of execution result presentation processing at the time of an interruptive utterance.

FIG. 10 is a flowchart for describing a flow of the execution result presentation processing at the time of another user's interruptive utterance.

FIG. 11 is a flowchart for describing a flow of reception period setting processing.

FIG. 12 is a diagram illustrating a configuration example of a computer.

### MODE FOR CARRYING OUT THE INVENTION

Hereinafter, embodiments of the present technology will be described with reference to the drawings. Note that the description will be given in the following order.

1. Embodiment of Present Technology

2. Modification

3. Configuration of Computer

### 1. Embodiment of Present Technology

(Configuration Example of Voice Interaction System)

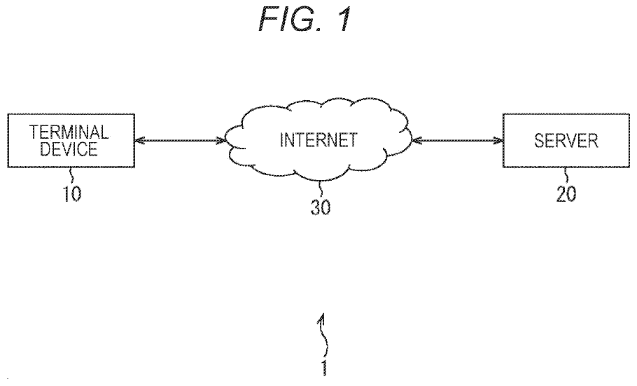

FIG. 1 is a block diagram illustrating an example of a configuration of a voice interaction system to which the present technology is applied.

A voice interaction system 1 includes a terminal device 10 installed on a local side such as a user's home and a server 20 installed on a cloud side such as a data center. In the voice interaction system 1, the terminal device 10 and the server 20 are connected to each other via the Internet 30.

The terminal device 10 is a device connectable to a network such as a home local area network (LAN), and executes processing for implementing a function as a user interface of a voice interaction service.

For example, the terminal device 10 is also called a home agent (agent) or the like, and has functions of voice interaction with a user, playback of music, and voice operation for devices such as a lighting fixture and an air conditioner.

Note that the terminal device 10 is configured as a dedicated terminal, or may be configured as, for example, a mobile device such as a speaker (so-called smart speaker), a game device, or a smartphone, or an electronic device such as a tablet computer or a television receiver.

The terminal device 10 can provide the user with (a user interface of) the voice interaction service by cooperating with the server 20 via the Internet 30.

For example, the terminal device 10 collects a voice (user utterance) emitted by the user, and transmits voice data to the server 20 via the Internet 30. Furthermore, the terminal device 10 receives processed data transmitted from the server 20 via the Internet 30, and presents information such as an image and a voice according to the processed data.

The server 20 is a server that provides a cloud-based voice interaction service, and executes processing for implementing a voice interaction function.

For example, the server 20 executes processing such as voice recognition processing and semantic analysis processing on the basis of the voice data transmitted from the terminal device 10 via the Internet 30, and transmits processed data according to a result of the processing to the terminal device 10 via the Internet 30.

Note that FIG. 1 illustrates a configuration in which one terminal device 10 and one server 20 are provided. However, a plurality of the terminal devices 10 may be provided and data from the terminal devices 10 may be processed by the server 20 in a concentrated manner. Furthermore, for example, one or a plurality of the servers 20 may be provided for each function such as voice recognition or semantic analysis.

(Functional Configuration Example of Voice Interaction System)

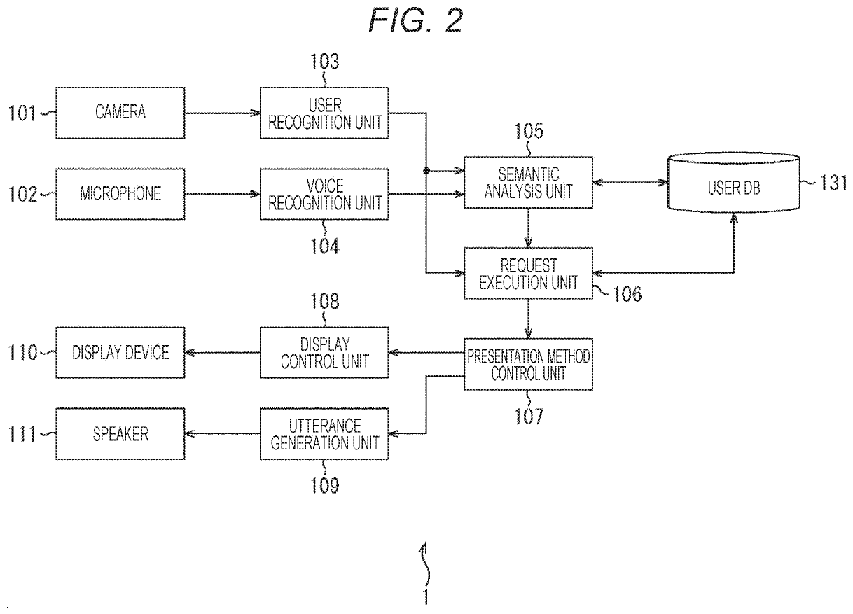

FIG. 2 is a block diagram illustrating an example of a functional configuration of the voice interaction system 1 illustrated in FIG. 1.

In FIG. 2, the voice interaction system 1 includes a camera 101, a microphone 102, a user recognition unit 103, a voice recognition unit 104, a semantic analysis unit 105, a request execution unit 106, a presentation method control unit 107, a display control unit 108, an utterance generation unit 109, a display device 110, and a speaker 111. Furthermore, the voice interaction system 1 includes a database such as a user DB 131.

The camera 101 includes an image sensor and supplies image data obtained by imaging an object such as a user to the user recognition unit 103.

The microphone 102 supplies voice data obtained by converting a voice uttered by the user into an electrical signal to the voice recognition unit 104.

The user recognition unit 103 executes user recognition processing on the basis of the image data supplied from the camera 101, and supplies a result of the user recognition to the semantic analysis unit 105.

In the user recognition processing, the image data is analyzed, and a user around the terminal device 10 is detected (recognized). Furthermore, in the user recognition processing, a direction of the user's line-of-sight, a direction of the face, or the like may be detected using a result of the image analysis.

The voice recognition unit 104 executes voice recognition processing on the basis of the voice data supplied from the microphone 102, and supplies a result of the voice recognition to the semantic analysis unit 105.

In the voice recognition processing, processing of converting the voice data from the microphone 102 into text data is executed by appropriately referring to a database for voice-text conversion or the like, for example.

The semantic analysis unit 105 executes semantic analysis processing on the basis of a result of voice recognition supplied from the voice recognition unit 104, and supplies a result of semantic analysis to the request execution unit 106.

In the semantic analysis processing, processing of converting the result of the voice recognition (text data) that is a natural language into an expression understandable by a machine (system) by appropriately referring to a database for voice language understanding or the like is executed, for example. Here, for example, as the result of semantic analysis, a meaning of the utterance is expressed in the form of “intention (Intent)” that the user wants to execute and “entity information (Entity)” that is a parameter of the intention.

Note that, in the semantic analysis processing, the user information recorded in the user DB 131 may be appropriately referred to on the basis of the result of user recognition supplied from the user recognition unit 103, and information regarding a target user may be reflected in the result of semantic analysis.

The request execution unit 106 executes processing in response to a request of the user (hereinafter also referred to as request corresponding processing) on the basis of the result of semantic analysis supplied from the semantic analysis unit 105, and supplies a result of the execution to the presentation method control unit 107.

In the request corresponding processing, the user information recorded in the user DB 131 can be appropriately referred to on the basis of the result of user recognition supplied from the user recognition unit 103, and the information regarding a target user can be applied.

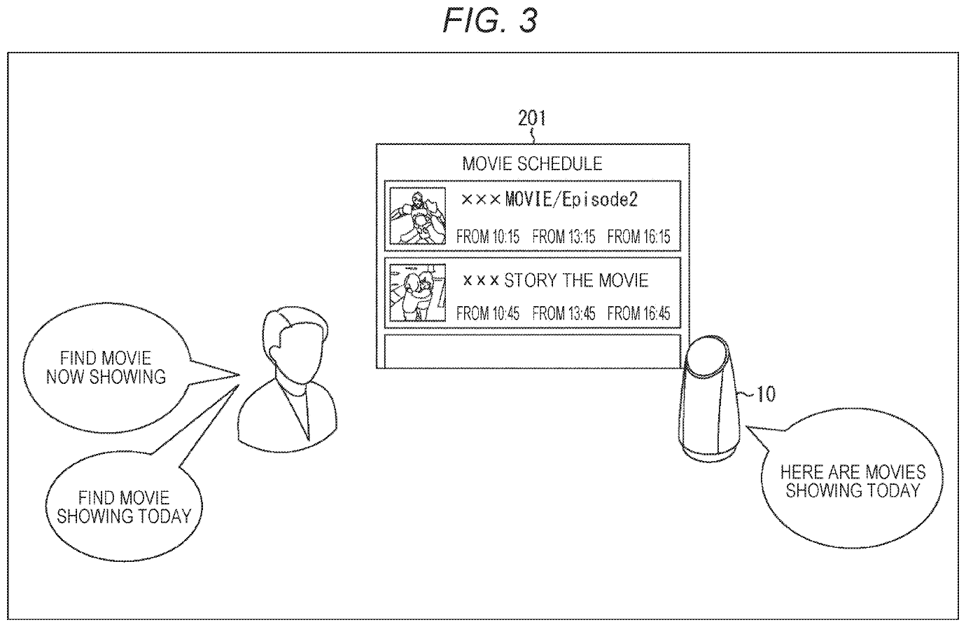

The presentation method control unit 107 executes presentation method control processing on the basis of the result of the execution supplied from the request execution unit 106, and controls at least one presentation method (presentation of output modal) of the display control unit 108 and the utterance generation unit 109 on the basis of a result of the processing. Note that details of the presentation method control processing will be described below with reference to FIGS. 3 to 8.

The display control unit 108 executes display control processing according to the control from the presentation method control unit 107, and displays (presents) information (a system response) such as an image and a text on the display device 110.

The display device 110 is configured as, for example, a projector, and projects a screen including the information such as an image and a text on a wall surface, a floor surface, or the like. Note that the display device 110 may be configured by a display such as a liquid crystal display or an organic EL display.

The utterance generation unit 109 executes utterance generation processing (for example, voice synthesis processing (text to speech: TTS) or the like) according to the control from the presentation method control unit 107, and outputs a response voice (system response) obtained as a result of the utterance generation from the speaker 111. Note that the speaker may output music such as BGM in addition to the voice.

The database such as the user DB 131 is recorded on a recording unit such as a hard disk or a semiconductor memory. The user DB 131 records user information regarding a user. Here, the user information can include any type of information regarding the user, for example, personal information such as name, age, and gender, use history information of the system functions, applications, and the like, and characteristic information such as a habit and an utterance tendency at the time of a user's utterance.

The voice interaction system 1 is configured as described above.

Note that which of the terminal device 10 (FIG. 1) and the server 20 (FIG. 1) the camera 101 to the speaker 111 are incorporated into is arbitrary in the voice interaction system 1 in FIG. 2. The configuration can be, for example, as follows.

That is, the camera 101, the microphone 102, the display device 110, and the speaker 111, which function as a user interface, are incorporated in the local-side terminal device 10, whereas the user recognition unit 103, the voice recognition unit 104, the semantic analysis unit 105, the request execution unit 106, the presentation method control unit 107, the display control unit 108, and the utterance generation unit 109, which are the other functions, can be incorporated in the cloud-side server 20.

(Presentation Method Control Processing)

Next, details of presentation method control processing executed by the presentation method control unit 107 will be described.

In the presentation method control processing, a result of execution of processing (request corresponding processing) in response to a request of the user is presented on the basis of one presentation method of presentation methods (A) to (E) described below, for example.

(A) Present a result of integrated execution in a case of equivalent intentions

(B) Present a result of execution with an additional condition in a case where there is an addition of condition

(C) Present a result of execution with a partially changed condition in a case where there is a change in condition

(D) Present respective results of execution in a case of different intentions

(E) Regard an utterance as not an interruptive utterance and ignore the utterance in a case where the utterance is not for the system

Hereinafter, details of the above-described presentation methods (A) to (E) will be sequentially described with reference to FIGS. 3 to 8.

(A) First Presentation Method

In the above-described first presentation method (A), in a case where intentions of a preceding user utterance and a subsequent user utterance are equivalent (substantially the same), the preceding and subsequent user utterances are integrated into one, and a result of execution of the request corresponding processing according to the request of the integrated utterance is presented.

Here, for example, a scene in which a first interaction is performed, as illustrated in FIG. 3, is assumed as an interaction between the user and the system. Note that, in the following description, a user's utterance is written as “U (User)” and a response voice of the home console system is written as “S (System)” in the interaction.

### Example of First Interaction

U: “Find a movie now showing”

U: “Tell me a movie showing today”

S: “Here are movies showing today”

In this first interaction example, the preceding user utterance of “Find a movie now showing” and the subsequent user utterance (interruptive utterance) of “Tell me a movie showing today” are successively made by the user during a reception period.

At this time, the voice interaction system 1 can obtain Intent=“movie schedule confirmation” and Entity=“now” or “today” as a result of semantic analysis although results of voice recognition are different between the preceding user utterance and the subsequent user utterance, and thus can determine that the intentions are equivalent (substantially the same).

Then, the voice interaction system 1 integrates (preceding processing for) the preceding user utterance and (subsequent processing for) the subsequent user utterance into one processing and executes processing (equivalent request corresponding processing) according to the request of the user on the basis of, for example, the result of semantic analysis of Intent=“movie schedule confirmation” and Entity=“today”, and presents a result of the execution.

Therefore, as illustrated in FIG. 3, in the terminal device 10, a list of movie schedule of today's movies (including Japanese and foreign movies) is presented (displayed) in a display area 201 by the display device 110, and a response voice of “Here are movies showing today” is presented (output) by the speaker 111. As a result, the user can receive desired presentation matching the intention of his/her own utterance even in the case where the user makes the subsequent user utterance (interruptive utterance) having equivalent content with respect to the preceding user utterance.

As described above, the voice interaction system 1 integrates the processing to one processing so as not to repeat equivalent processing a plurality of times in the case where the results of semantic analysis of the preceding user utterance and the subsequent user utterance are equivalent.

If the processing is not integrated into one processing in such a case, similar processing is repeated a plurality of times, and a list of the same movie schedule is repeatedly presented to the user. The user may find it uncomfortable to repeatedly check the same information. Furthermore, repeating similar processing is also useless for the system side.

Note that, here, for the sake of description, an example of integrating the processing into one processing in the case where the intentions of the preceding and subsequent user utterances are equivalent has been described. However, an embodiment is not limited thereto, and for example, in a case where the preceding processing for the preceding user utterance has already been executed and a result of the execution is being previously presented, the subsequent processing for the subsequent user utterance may be stopped (presentation may be stopped). That is, it is only required to stop repetitive execution of similar processing in the case where intentions are equivalent between the preceding and subsequent user utterances, and the implementation method is arbitrary.

(B) Second Presentation Method

In the above-described second presentation method (B), in a case where a condition is added to the preceding user utterance by the subsequent utterance, content (condition) of the subsequent user utterance is added to content of the preceding user utterance, and a result of execution of the request corresponding processing according to the request of the added content is presented.

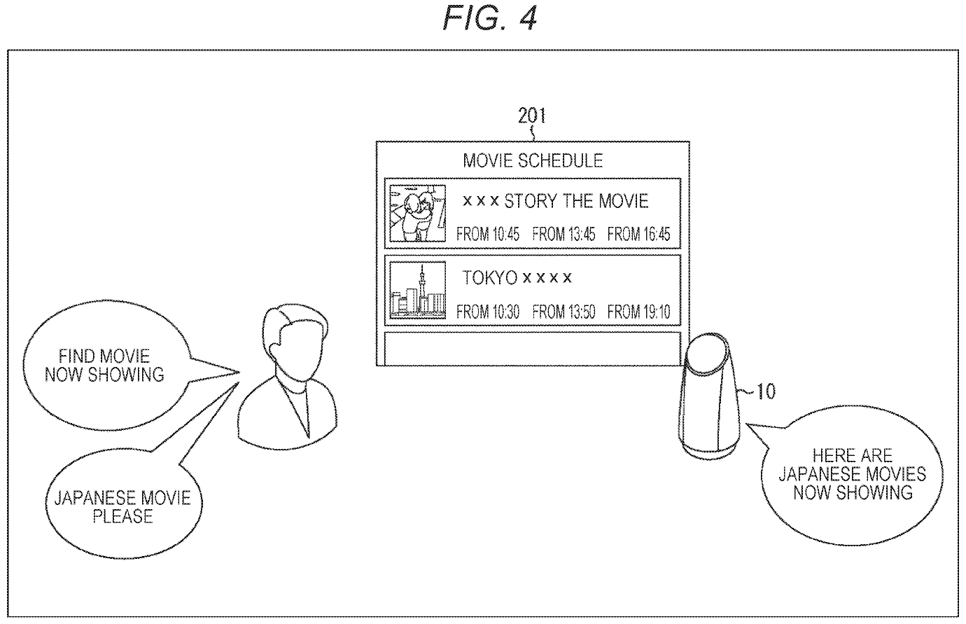

Here, for example, a scene in which a second interaction is performed, as illustrated in FIG. 4, is assumed as an interaction between the user and the system.

### Example of Second Interaction

U: “Find a movie now showing”

U: “A Japanese movie please”

S: “Here are Japanese movies now showing”

In this second interaction example, the preceding user utterance of “Find a movie now showing” and the subsequent user utterance (interruptive utterance) of “Japanese movie please” are successively made by the user during the reception period. At this time, the voice interaction system 1 can obtain Intent=“movie schedule confirmation” and Entity=“now”, for example, as a result of semantic analysis for the preceding user utterance and obtain Entity=“Japanese movie”, for example, as a result of semantic analysis for the subsequent user utterance.

At this time, the voice interaction system 1 can determine that the result of semantic analysis for the subsequent user utterance (Entity=“Japanese movie”) is a condition (missing information) to be added to the result of semantic analysis for the preceding user utterance (Intent=“movie schedule confirmation” and Entity=“now”) on the basis of the results of semantic analysis.

Then, the voice interaction system 1 adds the result of semantic analysis for the subsequent user utterance to the result of semantic analysis for the preceding user utterance, and executes processing (additional request corresponding processing) according to the request of the user on the basis of the results of semantic analysis of Intent=“movie schedule confirmation” and Entity=“today” and “Japanese movie”, and presents a result of the execution.

Therefore, as illustrated in FIG. 4, in the terminal device 10, a list of movie schedule of today's Japanese movies is presented (displayed) in the display area 201 by the display device 110, and a response voice of “Here are Japanese movies now showing” is presented (output) by the speaker 111. As a result, the user can receive desired presentation matching the intention of his/her own utterance even in the case where the user adds the condition (missing information) in the subsequent user utterance (interruptive utterance) to the preceding user utterance.

Note that, here, for the sake of description, an example of adding the content (condition) of the subsequent user utterance to the content of the preceding user utterance and executing the processing has been described. However, an embodiment is not limited thereto, and for example, in a case where the preceding processing for the preceding user utterance has already been executed and a result of the execution is being previously presented, the subsequent processing for the subsequent user utterance may be executed, and additional information obtained as a result of the execution may be presented following the previously presented information.

(C) Third Presentation Method

In the above-described third presentation method (C), in a case where a part of the condition of the preceding user utterance is changed by the subsequent user utterance, the part of the content of the preceding user utterance is changed to the content of the subsequent user utterance, and a result of execution of the request corresponding processing according to the request of the changed content is presented.

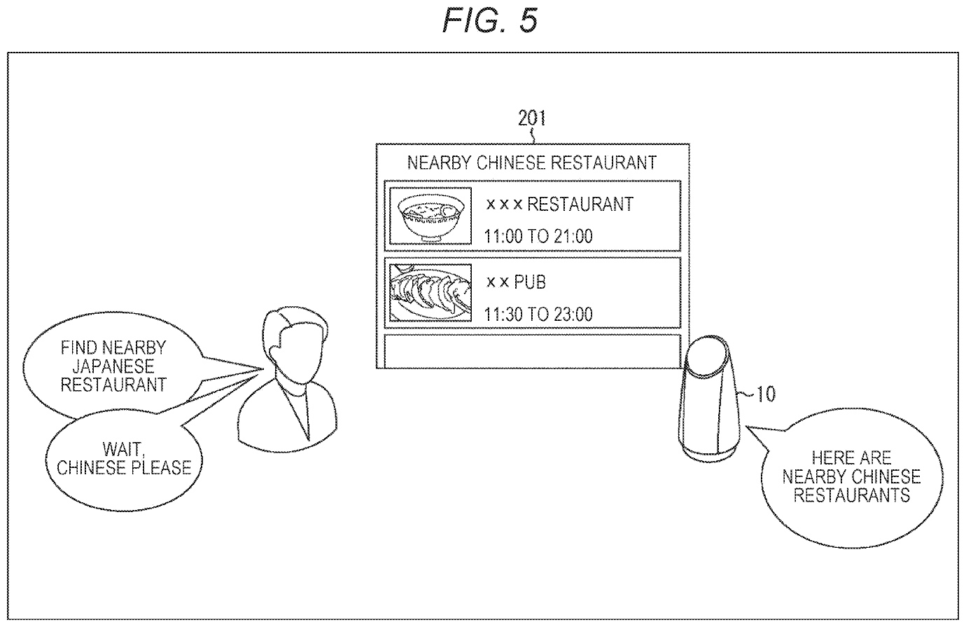

Here, for example, a scene in which a third interaction is performed, as illustrated in FIG. 5, is assumed as an interaction between the user and the system.

### Example of Third Interaction

U: “Find a nearby Japanese restaurant”

U: “Wait, Chinese please”

S: “Here are nearby Chinese restaurants”

In this third interaction example, the preceding user utterance of “Find a nearby Japanese restaurant” and the subsequent user utterance (interruptive utterance) of “Wait, Chinese please” are successively made by the user during the reception period. At this time, the voice interaction system 1 can obtain Intent=“restaurant search” and Entity=“nearby” and “Japanese”, for example, as a result of semantic analysis for the preceding user utterance and obtain Entity=“Chinese” as a result of semantic analysis for the subsequent user utterance, for example.

At this time, the voice interaction system 1 can determine that the result of semantic analysis for the subsequent user utterance (Entity=“Chinese”) is a condition (information for change) to change a part of the result of semantic analysis for the preceding user utterance (Intent=“restaurant search” and Entity=“nearby” and “Japanese”) on the basis of the results of semantic analysis.

Then, the voice interaction system 1 changes information of a part of the result of semantic analysis for the preceding user utterance on the basis of the result of semantic analysis for the subsequent user utterance, and executes processing (change request corresponding processing) according to the request of the user on the basis of the results of semantic analysis of Intent=“restaurant search” and Entity=“nearby” and “Chinese”, and presents a result of the execution, for example.

Note that, here, in the result of semantic analysis for the preceding user utterance, Entity=“Japanese” is changed to Entity=“Chinese” on the basis of the result of semantic analysis for the subsequent user utterance, and the change request corresponding processing is executed.

Therefore, as illustrated in FIG. 5, in the terminal device 10, a list of nearby Chinese restaurants is presented (displayed) in the display area 201 by the display device 110, and a response voice of “Here are nearby Chinese restaurants” is presented (output) by the speaker 111. As a result, the user can receive desired presentation matching the intention of his/her own utterance even in the case where the user changes the condition in the subsequent user utterance (interruptive utterance) with respect to the preceding user utterance.

Note that, here, for the sake of description, an example of changing the content of the preceding user utterance on the basis of the content (condition) of the subsequent user utterance and executing the processing has been described. However, an embodiment is not limited thereto, and for example, in a case where the preceding processing for the preceding user utterance has already been executed and a result of the execution is being previously presented (the response voice is being output), the output of the response voice may be stopped at an appropriate breakpoint of the response voice (for example, at a position of punctuation or the like), and then a result of execution of the subsequent processing for the preceding user utterance changed with the subsequent user utterance may be presented.

(D) Fourth Presentation Method

In the above-described fourth presentation method (D), in a case where the subsequent user utterance is made with respect to the preceding user utterance but the intentions of the utterances are different, the request corresponding processing according to each request is individually executed for each of the preceding user utterance and the subsequent user utterance, and results of execution are respectively presented.

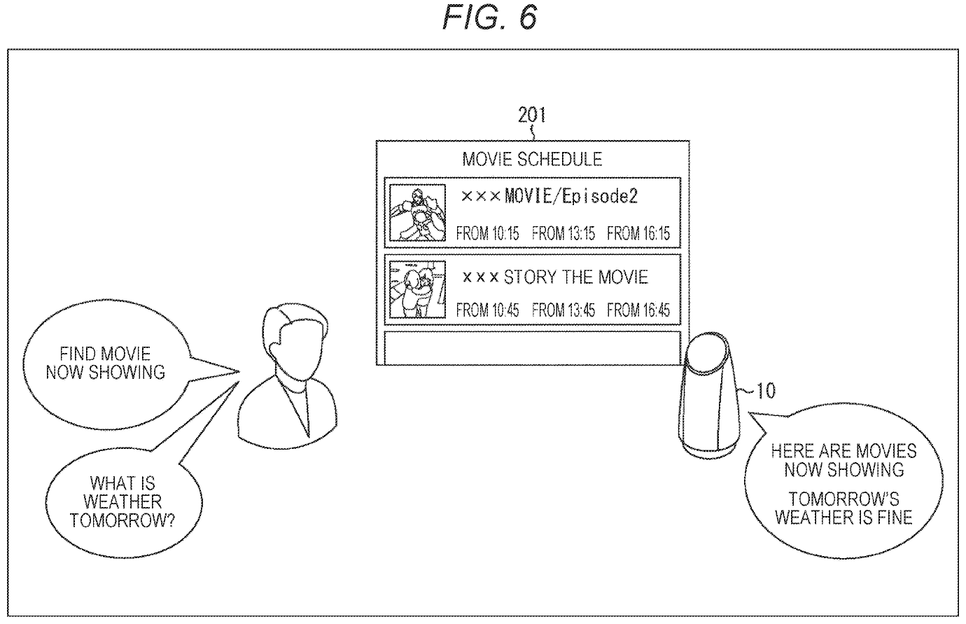

Here, for example, a scene in which a fourth interaction is performed, as illustrated in FIG. 6, is assumed as an interaction between the user and the system.

### Example of Fourth Interaction

U: “Find a movie now showing”

U: “What's the weather tomorrow?”

S: “Here are movies now showing. Tomorrow's weather is fine”.

In this fourth interaction example, the preceding user utterance of “Find a movie now showing” and the subsequent user utterance (interruptive utterance) of “What is the weather tomorrow?” are successively made by the user during the reception period. At this time, the voice interaction system 1 can obtain Intent=“movie schedule confirmation” and Entity=“now”, for example, as a result of semantic analysis for the preceding user utterance and obtain Intent=“confirm weather” and Entity=“tomorrow”, for example as a result of semantic analysis for the subsequent user utterance.

At this time, the voice interaction system 1 can determine that the intentions are completely different between the preceding user utterance and the subsequent user utterance on the basis of the results of semantic analysis. Then, the voice interaction system 1 individually executes the request corresponding processing according to the requests, for the preceding user utterance and for the subsequent user utterance.

For example, the voice interaction system executes processing (preceding request corresponding processing) according to the request based on the preceding user utterance on the basis of the result of semantic analysis of Intent=“movie schedule confirmation” and Entity=“now”, and executes processing (subsequent request corresponding processing) according to the request based on the subsequent user utterance on the basis of the result of semantic analysis of Intent=“confirm weather” and Entity=“tomorrow”. As a result, a result of execution of the preceding request corresponding processing and a result of execution of the subsequent request corresponding processing are respectively presented.

Therefore, as illustrated in FIG. 6, in the terminal device 10, a list of movie schedule of today's movies is presented (displayed) in the display area 201 by the display device 110, and a response voice of “Here are movies now showing. Tomorrow's weather is fine” is presented (output) by the speaker 111. As a result, the user can receive desired presentation matching the intention of his/her own utterance even in the case where the user makes the subsequent user utterance (interruptive utterance) having a different intention with respect to the preceding user utterance.

Note that, here, an example of a multimodal interface using image display by the display device 110 and voice output by the speaker 111 has been described as a presentation method for the result of execution of the preceding request corresponding processing and the result of execution of the subsequent request corresponding processing. However, another user interface may be adopted.

More specifically, for example, the display area 201 displayed by the display device 110 can be divided into upper and lower parts, and while the result of execution of the preceding request corresponding processing (for example, a list of movie schedule and the like) can be presented in the upper part, the result of execution of the subsequent request corresponding processing (for example, tomorrow's weather forecast and the like) can be presented in the lower part. Moreover, a voice according to the result of execution of the preceding request corresponding processing and a voice according to the result of execution of the subsequent request corresponding processing may be sequentially output from the speaker 111.

Furthermore, the result of execution of the preceding request corresponding processing and the result of execution of the subsequent request corresponding processing may be presented by different devices. More specifically, while the result of execution of the preceding request corresponding processing can be presented by the terminal device 10, the result of execution of the subsequent request corresponding processing can be presented by a portable device (for example, a smartphone and the like) owned by the user. At that time, the user interface (modal) used in one device and the user interface (modal) used in the other device may be the same or may be different.

(E) Fifth Presentation Method

In the above-described fifth presentation method (E), in a case where the subsequent user utterance is made with respect to the preceding user utterance but the subsequent user utterance is not an interruptive utterance, only the processing (preceding request corresponding processing) according to the request based on the preceding user utterance is executed, and a result of the execution is presented. That is, in this case, the processing (subsequent request corresponding processing) according to the request based on the subsequent user utterance is unexecuted, and the subsequent user utterance is ignored.

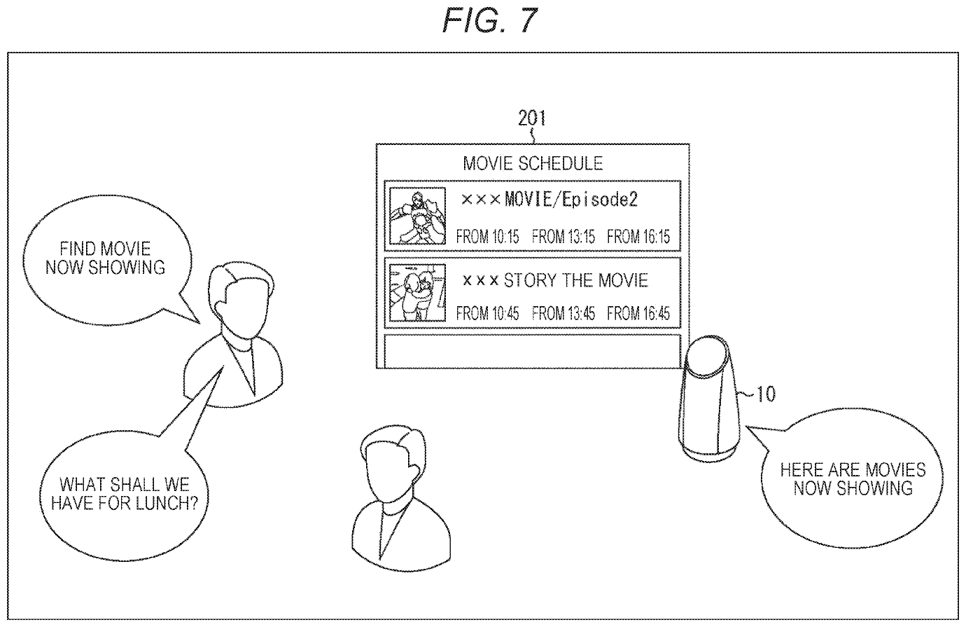

Here, for example, a scene in which a fifth interaction is performed, as illustrated in FIG. 7, is assumed as an interaction between the user and the system.

### Example of Fifth Interaction

U: “Find a movie now showing”

U: “What shall we have for lunch?”

S: “Here are the movies now showing”

In this fifth interaction example, the preceding user utterance of “Find a movie now showing” and the subsequent user utterance of “What shall we have for lunch?” are successively made by the user during the reception period. At this time, the voice interaction system 1 can obtain Intent=“movie schedule confirmation” and Entity=“now”, for example, as a result of semantic analysis for the preceding user utterance.

At this time, “What shall we have for lunch?” is made as the subsequent user utterance but the utterance is for another user and is not spoken to the system. Therefore, the voice interaction system 1 regards the subsequent user utterance not as an interruptive utterance and ignores the subsequent user utterance.

Here, as a method of determining whether or not the subsequent user utterance is an interruptive utterance, a result of voice recognition or a result of semantic analysis for the subsequent user utterance can be used, for example, or determination can be made on the basis of information such as a direction of the face or a line-of-sight of the user, which can be obtained by the user recognition processing for a captured image (for example, line-of-sight information indicating whether or not the line-of-sight of the user during the utterance is directed to the another user). Note that, in a case where the same utterance “What shall we have for lunch?” is interpreted (determined) as a request for the system, a recipe for lunch may be proposed, for example.

Then, the voice interaction system 1 executes the preceding request corresponding processing according to the request based on the preceding user utterance on the basis of the result of semantic analysis of Intent=“movie schedule confirmation” and Entity=“now”, and presents a result of the execution, for example.

Therefore, as illustrated in FIG. 7, in the terminal device 10, a list of movie schedule of today's movies (including Japanese and foreign movies) is presented (displayed) in the display area 201 by the display device 110, and a response voice of “Here are movies now showing” is presented (output) by the speaker 111. As a result, the user can receive desired presentation matching the intention of his/her own utterance even in the case where the user makes the subsequent user utterance that is not an interruptive utterance with respect to the preceding user utterance.

Note that, in the above-described presentation methods (A) to (D), in executing the subsequent processing (interruptive processing) for the subsequent user utterance (interruptive utterance), in a case where the preceding processing for the preceding user utterance has already been executed and a result of the execution is previously being presented (for example, a response voice is being output), a result of execution of the subsequent processing (interruptive processing) can be presented (for example, a response voice can be output) at an appropriate breakpoint of the preceding presentation (the output of the response voice, for example) (for example, after an utterance is made up to an appropriate breakpoint such as a position of punctuation).

Furthermore, in the above-described presentation methods (A) to (D), in executing the subsequent processing (interruptive processing) for the subsequent user utterance (interruptive utterance), in a case where it is determined that it seems to take some time to complete execution of the subsequent processing on the system side (in a case where processing time exceeds an allowable time), the subsequent user utterance may be intentionally ignored so that the subsequent processing is not executed.

Moreover, in the above-described presentation methods (A) to (D), an example of a multimodal interface (visual and auditory modal) using image display by the display device 110 and voice output by the speaker 111 has been described. However, for example, another modal such as tactile sensation caused by vibration of a device (for example, a smartphone or a wearable device) worn by the user may be used. Furthermore, in a case where a plurality of user utterances is made, such as the preceding user utterance and the subsequent user utterance, the results of execution of the request corresponding processing based on the respective user utterances may be presented by image display by the display device 110.

Note that the above-described processing is assumed to be an utterance that occurs by the end of execution of a request. However, even in a case where a long time is required to provide an execution result, such as a case, for example, where several days are required for the processing, the above-described processing can be similarly applied. In this case, a possibility that the user has forgotten the content of his/her own request is assumed. Therefore, the processing for the interrupted content may be performed while presenting the content of the preceding request to the side user.

As described above, the voice interaction system 1 controls the presentation method according to the situation of interruption or the content of an utterance at the occurrence of an interruptive utterance, by the above-described presentation methods (A) to (E), thereby making an appropriate response. Thus, for example, even if the user utters one after another, the system operates as intended by those utterances.

### Other Examples of Presentation Method

The above-described presentation methods (A) to (E) are merely examples, and for example, the following presentation methods can be used as other presentation methods.

### First Another Example

In the above-described presentation methods, cases where the preceding user utterance and the subsequent user utterance are made by the same user have been described. However, in a case where an interruptive utterance is made by another user, the preceding user utterance and the subsequent user utterance are made by different users. Here, a presentation method corresponding to such a scene will be described.

Here, in a case where a certain user makes the preceding user utterance, when another user makes the subsequent user utterance as an interruptive utterance, the request corresponding processing is executed and a result of the execution can be presented similarly to the above-described presentation methods (A) to (E).

More specifically, in the case where the intentions of the preceding user utterance and the subsequent user utterance are equivalent, the preceding and subsequent user utterances are integrated into one, and the result of execution of the request corresponding processing according to the request of the integrated utterance can be presented by the first presentation method, for example. Furthermore, for example, the content of the subsequent user utterance can be added to the content of the preceding user utterance by the second presentation method, or a part of the content of the preceding user utterance can be changed with the content of the subsequent user utterance by the third presentation method.

Furthermore, in the case where the same user utterances are made by different users, the request corresponding processing is executed as another request, and a result of the execution can be presented. For example, in a case where a certain user who has made the preceding user utterance and another user who has made the subsequent user utterance are at different places, the preceding request corresponding processing and the subsequent request corresponding processing are individually executed, and a result of execution of the preceding request corresponding processing can be presented to a device near the certain user, and a result of execution of the subsequent request corresponding processing can be presented to a device near the another user.

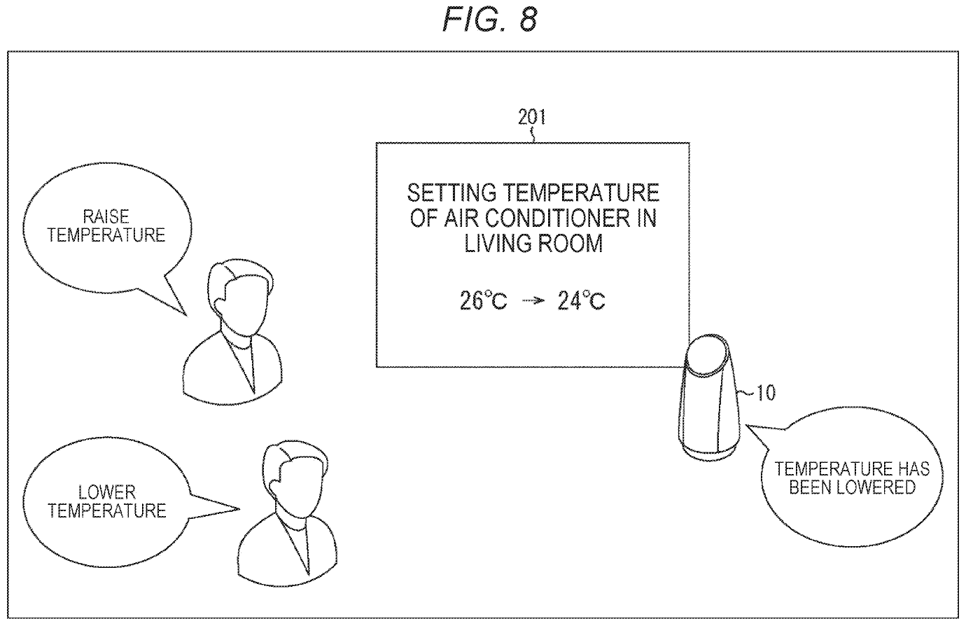

Next, for example, a scene in which a sixth interaction is performed, as illustrated in FIG. 8, is assumed as an interaction between the user and the system. Note that an utterance of a certain user is written as “U1” and an utterance of another user is written as “U2” to make a distinction in FIG. 8.

### Example of Sixth Interaction

U1: “Raise the temperature”

U2: “Lower the temperature”

S: “The temperature has been lowered”

In the sixth interaction example, the preceding user utterance of “Raise the temperature” by a certain user and the subsequent user utterance (interruptive utterance) of “Lower the temperature” by another user are successively made during the reception period. Here, the voice interaction system 1 can obtain Intent=“air conditioner setting” and Entity=“raise temperature”, for example, as a result of semantic analysis for the preceding user utterance and obtain Intent=“air conditioner setting” and Entity=“lower temperature”, for example, as a result of semantic analysis for the subsequent user utterance.

At this time, conflicted operation requests have been made between the preceding user utterance and the subsequent user utterance. The voice interaction system 1 adopts either one of the results of semantic analysis on the basis of the results of semantic analysis and information such as the user information, for example.

Here, an execution rate of past requests, a system operation history, and the like are recorded for each user, for example, as the user information in the user DB 131, whereby when conflicted operation requests are made, a user who seems to have stronger voice is predicted by adopting an operation request of a user having a higher execution rate of past requests or adopting a user's operation history having a longer system use history, or the like, and a request according to a result of the prediction can be selected.

Note that, for example, here, a user whose operation request should be prioritized may be set and registered in advance on a setting screen or by an operation request of a user who is closer to the system such as the terminal device 10. Furthermore, the user whose operation request is adopted may be switched according to a time zone such as morning or night.

Then, the voice interaction system 1 adopts the operation request of the user having a high execution rate of past requests, executes processing according to the user's request on the basis of the result of semantic analysis of Intent=“air conditioner setting” and Entity=“lower temperature”, and presents a result of the execution.

Therefore, as illustrated in FIG. 8, in the terminal device 10, a setting temperature of the air conditioner in the living room (changed from 26° C. to 24° C.) is presented (displayed) in the display area 201 by the display device 110, and a response voice of “The temperature has been lowered” is presented (output) by the speaker 111. In the case where conflicted operation requests are made by a plurality of users as described above, here, the another user who has made the subsequent user utterance (interruptive utterance) has a stronger voice. Therefore, the operation request from the another user has been adopted, and the setting temperature of the air conditioner has been lowered.

Furthermore, in the above example, a case of adopting the operation request from the user having a stronger voice has been described. However, in the case where conflicted requests are made such as “Raise the temperature” and “Lower the temperature”, the voice interaction system 1 may ask back the user using screen display or voice output such as “Which do you want?”, for example.

Moreover, for example, in the case of conflicted utterances, the mode is transitioned to a mode for causing a user who has a determination right to determine which of the preceding user utterance and the subsequent user utterance is adopted, and the operation request based on the determined user utterance may be adopted.

Furthermore, in a case where utterances by a plurality of users interfere with one another, which user's utterance is adopted may be specified by a user who has first made an utterance, for example. For example, in the above-described presentation example in FIG. 5, in the case where the preceding user utterance of “Find a nearby Japanese restaurant” and the subsequent user utterance of “Wait, Chinese please” are made by different users, an instruction on which of “Japanese” and “Chinese” is adopted is given by the user with an input operation or an utterance.

Note that, in the case where the preceding user utterance and the subsequent user utterance are made by different users, the priority or behaviors of the users may be changed for each application such as a search application or a device operation application, for example. For example, a setting can be performed such that the utterance of a certain user is prioritized in the search application, whereas the utterance of another user is prioritized in the device operation application.

### Second Another Example

Since the terminal device 10 is assumed to be used by various users by being installed on the local side such as a user's home and used not only by one user but also by a plurality of users such as family members, an execution result of the request corresponding processing can be more appropriately presented by personalizing the presentation timing of the execution result for each user.

For example, in a case of a user who speaks once and frequently conducts restatement, the timing to present the execution result is delayed, or a threshold value of end detection of the utterance is set longer. In particular, such personalization is effective for a user who frequently conducts restatement in a case where a part of the content of the preceding user utterance is changed with the content of the subsequent user utterance by the above-described third presentation method.

Furthermore, for example, in a case of a user who frequently speaks to himself/herself after making an utterance, there is a high possibility that the subsequent user utterance following the preceding user utterance is not an interruptive utterance, so the subsequent processing is not executed within the time when a clear request is made as a second user utterance. More specifically, cases where the user speaks to himself/herself as follows are assumed.

### First Self-Talk Example

U: “This?, good, hmmm, the second is good”

In the first self-talk example, the user talks to himself/herself such as “This?”, “good”, and “hmmm”, and the following user's utterance (subsequent user utterance) of “the second is good” is not a clear request and is not an interruptive utterance. Therefore, processing for the self-talk is not executed.

### Second Self-Talk Example

U: “This?, good, tell me details of the second”

In the second self-talk example, the user talks to himself/herself such as “This?” and “good”, and the following user's utterance (subsequent user utterance) of “Tell me details of the second” can be said to be a clear request. Therefore, the request corresponding processing for the request is executed, and an execution result is presented.

As described above, the voice interaction system 1 delays the timing to determine the end of an utterance for a user who frequently conducts restatement, hesitates to say, or uses fillers (for example, “er”, “uh”, etc.), for example, on the basis of the user information. Even if the user makes utterances one after another, the system can be operated as intended by those utterances.

Furthermore, the voice interaction system 1 may conduct restatement accordingly for the user who frequently conducts restatement.

### First System Restatement Example

S: “I have searched for xxx. Uh, additional xx, as well”

In the first system restatement example, a search request has been made as the preceding user utterance and a search request of restatement for the preceding user utterance has been made as the subsequent user utterance, by a user who frequently conducts restatement.

At this time, the voice interaction system 1 executes the request corresponding processing for the search request based on the preceding user utterance, and presents (outputs) an execution request with a response voice of “I have searched for xxx”. Furthermore, the voice interaction system 1 executes the request corresponding processing for the search request based on the subsequent user utterance (restated utterance), and presents (outputs) an execution result with a response voice of “Uh, additional xx, as well” in accordance with the user's restated utterance.

### Second System Restatement Example

S: “I have searched for xxx, but it was xx, this is it”

In the second system restatement example, a search request of restatement for the preceding user utterance has been made as the subsequent user utterance, similarly to the first system restatement example. At this time, the voice interaction system 1 executes the request corresponding processing for the search request of restatement, and presents (outputs) an execution result with a response voice of “but it was xx, this is it” in accordance with the user's restated utterance.

Note that the above-described personalization information (for example, information such as a habit of restatement) can be recorded for each user as the user information in the user DB 131.

For example, by recording the way of saying restatement at certain timing, for the user who frequently conducts restatement, as the user information, the voice interaction system 1 detects the restatement start position on the basis of the user information when the user conducts the way of saying restatement as the subsequent user utterance (restated utterance) in the next or subsequent time. Then, the voice interaction system 1 can cancel presentation of the execution result of the preceding request corresponding processing for the request based on the preceding user utterance, or can change and present the execution result of the preceding request corresponding processing with the execution result of the subsequent request corresponding processing, on the basis of the detected restatement start position.

### Third Another Example

Note that the voice interaction system 1 can change the way of execution of the request according to the content (type) of the utterance when the subsequent user utterance is made by the user in the case where presentation of the execution result of the preceding request corresponding processing for the request based on the preceding user utterance has already been started, and also can execute similar operation to the above-described presentation methods (A) to (E) if the processing after semantic analysis (preceding request corresponding processing) is being executed (after the start) even in a case where the presentation of the execution result of the preceding request corresponding processing has not been started.

(Flow of Execution Result Presentation Processing)

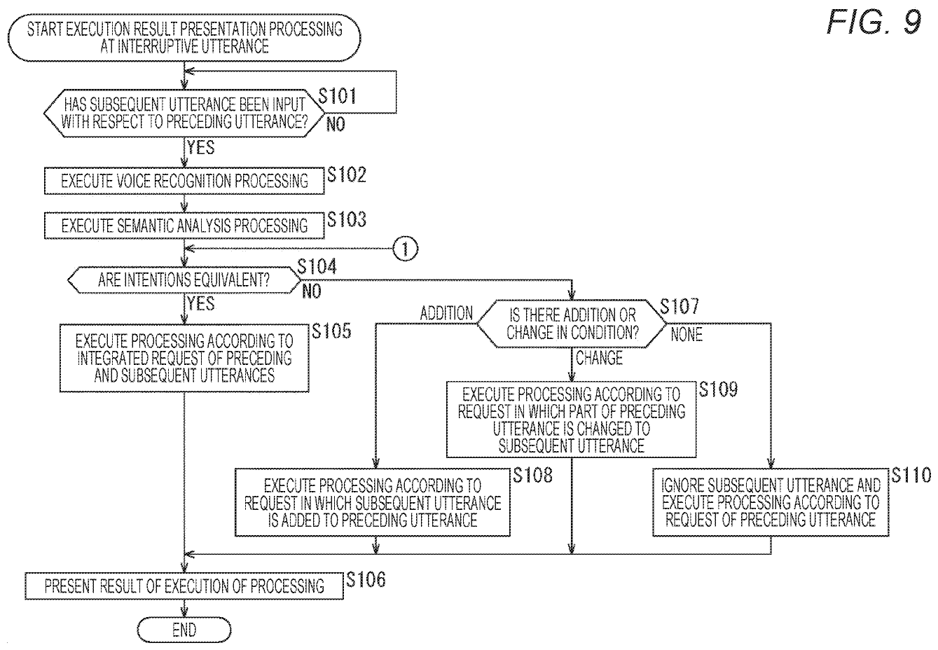

Next, a flow of execution result presentation processing at the time of an interruptive utterance, which is executed by the voice interaction system 1, will be described with reference to the flowchart in FIG. 9.

Note that, in executing the execution result presentation processing at the time of an interruptive utterance, it is assumed that the user has made the preceding user utterance, and the voice interaction system 1 has executed the voice recognition processing and the semantic analysis processing for the preceding user utterance and has obtained a result of semantic analysis (Intent and Entity) of the preceding user utterance. Furthermore, it is assumed that the preceding user utterance and the subsequent user utterance are made by the same user.

In step S101, the voice recognition unit 104 determines whether or not the subsequent user utterance has been input with respect to the preceding user utterance during the reception period.

In step S101, in a case of determining that the subsequent user utterance has not been input with respect to the preceding user utterance during the reception period, the determination processing in step S101 is repeated because the interruptive utterance has not been made.

In step S101, in a case of determining that the subsequent user utterance has been input with respect to the preceding user utterance during the reception period, the processing proceeds to step S102.

In step S102, the voice recognition unit 104 executes the voice recognition processing on the basis of the voice data obtained by collecting the subsequent user utterance.

In step S103, the semantic analysis unit 105 executes the semantic analysis processing on the basis of the result of the voice recognition obtained in the processing in step S102. By the semantic analysis processing, the result of semantic analysis (Intent and Entity) of the subsequent user utterance is obtained.

In step S104, the request execution unit 106 determines whether or not the intention of the preceding user utterance and the intention of the subsequent user utterance are equivalent (substantially the same) on the basis of the already acquired result of semantic analysis of the preceding user utterance and the result of semantic analysis of the subsequent user utterance obtained in the processing in step S103.

In step S104, in a case of determining that the intention of the preceding user utterance and the intention of the subsequent user utterance are equivalent, the processing proceeds to step S105.

In step S105, the request execution unit 106 executes the processing according to the request obtained by integrating the intention of the preceding user utterance and the intention of the subsequent user utterance (equivalent request corresponding processing).

In step S106, the presentation method control unit 107 presents the result of execution of the equivalent request corresponding processing obtained in the processing in step S105.

That is, in the processing in steps S105 and 106, when the results of semantic analysis are equivalent (substantially the same) between the preceding and subsequent user utterances even in the case where the results of voice recognition are different between the preceding and subsequent user utterances, the preceding user utterance and the subsequent user utterance are integrated into one so that a similar response is not presented a plurality of times by the above-described first presentation method.

Here, as the processing executed by the request execution unit 106, only a result of execution of one processing is presented by integrating the preceding processing for the preceding user utterance and the subsequent processing for the subsequent user utterance into one processing, or stopping the subsequent processing in the case where the preceding processing is already being executed, for example. Therefore, repetitive execution of processing according to an equivalent request can be suppressed. Note that the subsequent processing is only required to be similarly stopped in the case where the preceding processing for the preceding user utterance has already been executed and the result of the execution is previously being presented.

For example, as illustrated in FIG. 3 above, in the case where the preceding user utterance of “Find a movie now showing” and the subsequent user utterance of “Tell me a movie showing today” are made, it can be said that the results of semantic analysis are equivalent between the preceding and subsequent user utterances. Therefore, movie schedule confirmation processing is performed on the basis of a request obtained by integrating the preceding and subsequent user utterances.

Then, the presentation method control unit 107 controls the display control unit 108 or the utterance generation unit 109 to cause the display device 110 or the speaker 111 to present the result of execution of the processing For example, as illustrated in FIG. 3 above, the display device 110 presents (displays) the list of movie schedule in the display area 201 according to the control of the display control unit 108. Furthermore, for example, the speaker 111 presents (outputs) the response voice of “Here are movies now showing” according to the control of the utterance generation unit 109.

On the other hand, in step S104, in a case of determining that the intention of the preceding user utterance and the intention of the subsequent user utterance are not equivalent, the processing proceeds to step S107.

In step S107, the request execution unit 106 determines whether or not there is an addition or a change in condition to the content of the preceding user utterance on the basis of the content of the subsequent user utterance.

In step S107, in a case of determining that there is an addition or a change in condition to the content of the preceding user utterance on the basis of the content of the subsequent user utterance, the processing proceeds to step S108.

In step S108, the request execution unit 106 executes the processing according to the request obtained by adding the content (condition) of the subsequent user utterance to the content of the preceding user utterance (additional request corresponding processing).

When the processing in step S108 ends, the processing proceeds to step S106. In step S106, the presentation method control unit 107 presents the result of execution of the additional request corresponding processing obtained in the processing in step S108.

That is, in the processing in steps S108 and 106, in the case where there is an addition of condition to the preceding user utterance on the basis of the subsequent user utterance, the content of the subsequent processing (missing information) is added to the content of the preceding user utterance, and a more detailed result of execution is presented, by the above-described second presentation method.

For example, as illustrated in FIG. 4 above, in the case where the preceding user utterance of “Find a movie now showing” and the subsequent user utterance of “Japanese movie please” are made, the movie schedule confirmation processing is performed on the basis of the request obtained by adding the result of semantic analysis (Entity=“Japanese movie”) of the subsequent user utterance to the result of semantic analysis (Intent=“movie schedule confirmation” and Entity=“now”) of the preceding user utterance.

Therefore, a list of movie schedule of Japanese movies is presented in the display area 201 by the display device 110, and a response voice of “Here are Japanese movies now showing” is presented by the speaker 111, according to the control of the presentation method control unit 107.

Note that, here, for example, as the processing executed by the request execution unit 106, in a case where the preceding processing for the preceding user utterance has already been executed and a result of the execution is being previously presented, the subsequent processing for the subsequent user utterance may be executed, and additional information obtained as a result of the execution may be presented following the previously presented information, for example.

Furthermore, in step S107, in a case of determining that there is a change in condition to the content of the preceding user utterance on the basis of the content of the subsequent user utterance, the processing proceeds to step S109.

In step S109, the request execution unit 106 executes the processing according to the request obtained by changing a part of the content of the preceding user utterance with the content (condition) of the subsequent user utterance (change request corresponding processing).

When the processing in step S109 ends, the processing proceeds to step S106. In step S106, the presentation method control unit 107 presents the result of execution of the change request corresponding processing obtained in the processing in step S109.

That is, in the processing in steps S109 and 106, in the case where there is a change in condition to the preceding user utterance on the basis of the subsequent user utterance, a part of the content of the preceding user utterance is changed with the content (information to change) of the subsequent user utterance, and a more accurate result of execution is presented, by the above-described third presentation method.

For example, as illustrated in FIG. 5 above, in the case where the preceding user utterance of “Find a nearby Japanese restaurant” and the subsequent user utterance of “Wait, Chinese please” are made, restaurant search processing is executed on the basis of the request obtained by changing “Japanese” that is a part of the result of semantic analysis (Intent=“restaurant search” and Entity=“nearby” and “Japanese”) of the preceding user utterance with “Chinese” that is the result of semantic analysis for the subsequent user utterance.

Therefore, a list of nearby Chinese restaurants is presented in the display area 201 by the display device 110, and a response voice of “Here are nearby Chinese restaurants” is presented by the speaker 111, according to the control of the presentation method control unit 107.

Note that, here, for example, in a case where the preceding processing for the preceding user utterance has already been executed and a result of the execution is being previously presented (the response voice is being output), the output of the response voice may be stopped at an appropriate breakpoint of the response voice (for example, at a position of punctuation or the like), and then a result of execution of the subsequent processing for the preceding user utterance changed with the subsequent user utterance may be presented (a response voice may be output), for example.

Moreover, in step S107, in a case of determining that there is no addition or change in condition to the content of the preceding user utterance on the basis of the content of the subsequent user utterance, the processing proceeds to step S110.

In step S110, the request execution unit 106 regards the subsequent user utterance not as an interruptive utterance and ignores the subsequent user utterance, and executes the processing according to the request obtained from the content of the preceding user utterance (request corresponding processing without interruption).

When the processing in step S110 ends, the processing proceeds to step S106. In step S106, the presentation method control unit 107 presents the result of execution of the request corresponding processing without interruption obtained in the processing in step S110.

That is, in the processing in steps S110 and S106, in the case where the subsequent user utterance is not an interruptive utterance, the request corresponding processing without interruption is executed for only the request based on the preceding user utterance, and the subsequent user utterance is ignored, by the above-described fifth presentation method.

For example, as illustrated in FIG. 7 above, in the case where the preceding user utterance of “Find a movie now showing” and the subsequent user utterance of “What shall we have for lunch?” are made, the subsequent user utterance is regarded not as an interruptive utterance and is ignored because the subsequent user utterance is an utterance for another user and is not spoken to the system. Then, the movie schedule confirmation processing is executed on the basis of the request obtained from the result of semantic analysis (Intent=“movie schedule confirmation” and Entity=“now”) of the preceding user utterance.

When the processing in step S106 ends, the execution result presentation processing at the time of an interruptive utterance ends.

Note that, although not explicitly described, if the subsequent user utterance is an interruptive utterance, and the results of semantic analysis of the preceding user utterance and the subsequent user utterance are determined to have completely different intentions in the execution result presentation processing at the time of an interruptive utterance illustrated in FIG. 9, the preceding request corresponding processing and the subsequent request corresponding processing are respectively executed, and results of the execution are presented (for example, the above-described presentation example in FIG. 6).

A flow of the execution result presentation processing at the time of an interruptive utterance has been described.

(Flow of Execution Result Presentation Processing at Time of Another User's Interruptive Utterance)

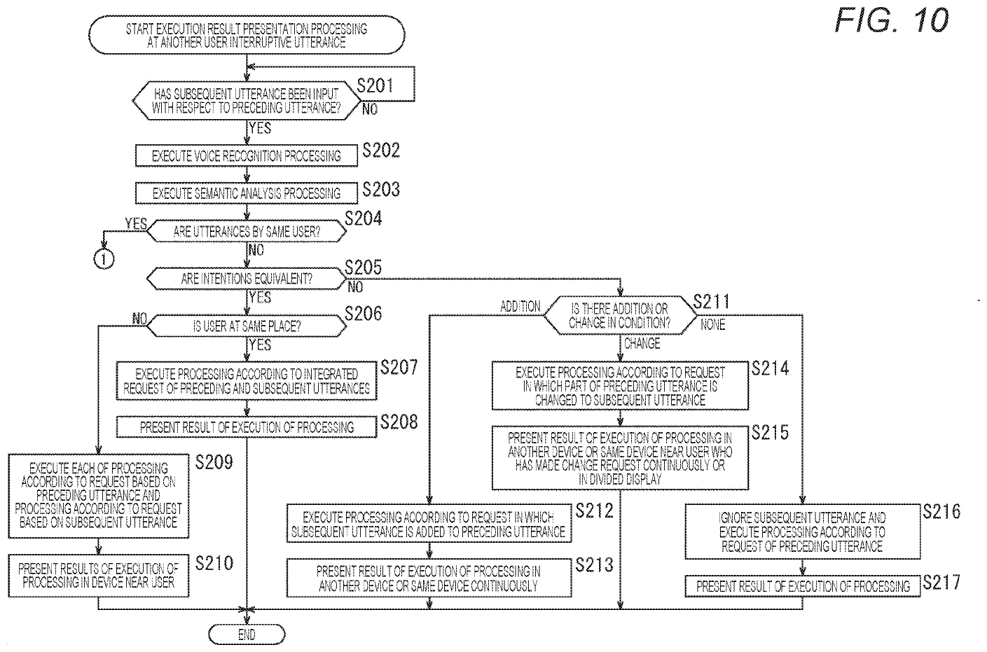

Next, a flow of execution result presentation processing at the time of another user's interruptive utterance, which is executed by the voice interaction system 1, will be described with reference to the flowchart in FIG. 10.

Note that, in executing the execution result presentation processing at the time of another user's interruptive utterance, it is assumed that a certain user has made the preceding user utterance, and the voice interaction system 1 has executed the voice recognition processing and the semantic analysis processing for the preceding user utterance and has obtained a result of semantic analysis (Intent and Entity) of the preceding user utterance.

In steps S201 to S203, when the subsequent user utterance is input with respect to the preceding user utterance during the reception period, the voice recognition processing and the semantic analysis processing are executed on the basis of the voice data obtained by collecting the subsequent user utterance, similarly to steps S101 to S103 in FIG. 9.

In step S204, the semantic analysis unit 105 determines whether or not the preceding user utterance and the subsequent user utterance are utterances by the same user.

In step S204, in a case of determining that the utterances are by the same user, the processing proceeds to the above-described processing in step S104 in FIG. 9. Note that description of processing for utterances by the same user, which is executed as processing in step S104 and subsequent steps in FIG. 9, is omitted as is redundant description.

Furthermore, in step S204, in a case of determining that the utterances are not by the same user, the processing proceeds to step S205. The following description will be given on the assumption that the user who makes the preceding user utterance and the user who makes the subsequent user utterance are different. Note that, hereinafter, for convenience of description, the user who makes the subsequent user utterance is referred to as another user and distinguished from the user who makes the preceding user utterance.

In step S205, whether or not the intention of the preceding user utterance and the intention of the subsequent user utterance are equivalent (substantially the same) is determined, similarly to step S104 in FIG. 9 above. In step S205, in a case of determining that the intentions are equivalent, the processing proceeds to step S206.

In step S206, the request execution unit 106 determines whether or not the user who has made the preceding user utterance and the another user who has made the subsequent user utterance are at the same place. Here, processing of determining whether or not the users are at the same place is executed on the basis of results of the user recognition processing, for example.

In step S206, in a case of determining that the users are at the same place, the processing proceeds to step S207.

In step S207, the request execution unit 106 executes the processing according to the request obtained by integrating the intention of the preceding user utterance and the intention of the subsequent user utterance (equivalent request corresponding processing).

In step S208, the presentation method control unit 107 presents the result of execution of the equivalent request corresponding processing obtained in the processing in step S207.

That is, in the processing in steps S207 and S208, since the users are at the same place even in the case where the preceding user utterance and the subsequent user utterance are made by different users, the preceding user utterance and the subsequent user utterance are integrated into one so that a similar response is not presented a plurality of times, and a result of execution according to the request of the integrated utterance is presented, when the results of semantic analysis are equivalent between the preceding and subsequent user utterances, similarly to the processing in steps S105 and S106 in FIG. 9 above (for example, the above-described presentation example in FIG. 3).

Note that, in the processing in step S208, for example, in the case where the preceding processing is already being executed as the processing executed by the request execution unit 106, repetitive execution of processing according to an equivalent request can be suppressed by stopping the subsequent processing or the like. Furthermore, in the case where the preceding processing for the preceding user utterance has already been executed and the result of the execution is previously being presented, the subsequent processing is only required to be similarly stopped.

Furthermore, in step S206, in a case of determining that the users are not at the same place, the processing proceeds to step S209.

In step S209, the request execution unit 106 individually executes each of the processing (preceding request corresponding processing) according to the request based on the preceding user utterance and the processing (subsequent request corresponding processing) according to the request based on the subsequent user utterance.

In step S210, the presentation method control unit 107 presents the result of execution of the preceding request corresponding processing obtained in the processing in step S209 in a device (for example, the terminal device 10) near the user, and presents the result of execution of the subsequent request corresponding processing in a device (for example, a smartphone owned by the another user) near the another user.

That is, in the processing in steps S209 and S210, since the users who have uttered are at different places, the preceding request corresponding processing and the subsequent request corresponding processing are each executed, and the results of the execution are presented to the respective users. Note that, here, if the preceding request corresponding processing and the subsequent request corresponding processing can be integrated into one processing, the integrated processing may be executed, and a result of execution of the processing may be presented to each of the device near the user and the device near the another user.

On the other hand, in step S205, in a case of determining that the intention of the preceding user utterance and the intention of the subsequent user utterance are not equivalent, the processing proceeds to step S211.

In step S211, whether or not there is an addition or a change in condition to the content of the preceding user utterance on the basis of the content of the subsequent user utterance is determined similarly to step S107 in FIG. 9 above.

In step S211, in a case of determining that there is an addition of condition to the content of the preceding user utterance on the basis of the content of the subsequent user utterance, the processing proceeds to step S212.

In step S212, the request execution unit 106 executes the processing according to the request obtained by adding the content (condition) of the subsequent user utterance to the content of the preceding user utterance (additional request corresponding processing).

In step S213, the presentation method control unit 107 presents the result of execution of the additional request corresponding processing obtained in the processing in step S212 in a different device (for example, a smartphone owned by the another user) or the same device (for example, the terminal device 10) continuously (or successively).

That is, in the processing in steps S212 and 213, the content of the subsequent processing (missing information) is added to the content of the preceding user utterance, and a more detailed result of execution is presented, similarly to the processing in steps S108 and S106 in FIG. 9 above (for example, the above-described presentation example in FIG. 4).

Note that, in the processing in step S213, the result of execution of the additional request corresponding processing is continuously (or successively) presented in the different device or the same device. However, for example, in the case where the preceding processing for the preceding user utterance has already been executed and the result of the execution is being previously presented, the subsequent processing for the subsequent user utterance can be executed, and the additional information obtained as a result of the execution can be presented following the previously presented information.

Furthermore, in step S211, in a case of determining that there is a change in condition to the content of the preceding user utterance on the basis of the content of the subsequent user utterance, the processing proceeds to step S214.

In step S214, the request execution unit 106 executes the processing according to the request obtained by changing a part of the content of the preceding user utterance with the content (condition) of the subsequent user utterance (change request corresponding processing).

In step S215, the presentation method control unit 107 presents the result of execution of the change request corresponding processing obtained in the processing in step S214 in a different device (for example, a smartphone owned by the another user) near the another user who has requested the change, or the same device (for example, the terminal device 10) continuously (or successively), or in a divided display.

That is, in the processing in steps S214 and S215, in the case where there is a change in condition to the preceding user utterance on the basis of the subsequent user utterance, a part of the content of the preceding user utterance is changed with the content (information to change) of the subsequent user utterance, and a more accurate result of execution is presented, similarly to the processing in steps S109 and S106 in FIG. 9 (for example, the above-described presentation example in FIG. 5).

Note that, in the processing in step S215, for example, in a case where the preceding processing for the preceding user utterance has already been executed and a result of the execution is being previously presented (the response voice is being output), the response voice is completed and then a result of execution of the subsequent processing for the preceding user utterance changed with the subsequent user utterance may be presented (a response voice may be output), for example.

Moreover, in step S211, in a case of determining that there is no addition or change in condition to the content of the preceding user utterance, the processing proceeds to step S216.

In step S216, the request execution unit 106 regards the subsequent user utterance not as an interruptive utterance and ignores the subsequent user utterance, and executes the processing according to the request obtained from the content of the preceding user utterance (request corresponding processing without interruption).

In step S217, the presentation method control unit 107 presents the result of execution of the request corresponding processing without interruption obtained in the processing in step S216.

That is, in the processing in steps S216 and S217, the subsequent user utterance is an utterance for the another user and is not spoken to the system, and is thus ignored, similarly to the processing in steps S110 and S106 in FIG. 9 above. Then, the request corresponding processing without interruption is executed, and the result of the processing is presented (for example, the above-described presentation example in FIG. 7).

When the processing in step S208, S210, S213, S215, or S217 ends, the execution result presentation processing at the time of another user's interruptive utterance ends.

A flow of the execution result presentation processing at the time of another user's interruptive utterance has been described.

(Flow of Reception Period Setting Processing)

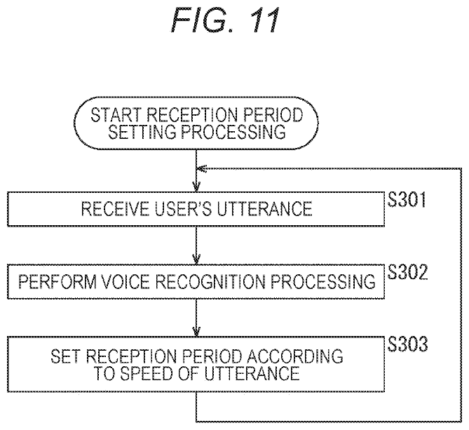

Next, a flow of reception period setting processing executed by the voice interaction system 1 will be described with reference to the flowchart in FIG. 11.

In step S301, the microphone 102 receives an utterance of the user by converting a voice uttered by the user into voice data.

In step S302, the voice recognition unit 104 performs the voice recognition processing on the basis of the voice data obtained in the processing in step S301. In the voice recognition processing, the speed of utterance of the user is detected on the basis of the voice data of the utterance of the user.

In step S303, the voice recognition unit 104 sets the reception period for interruptive utterance on the basis of the speed of utterance obtained in the processing in step S302.

When the process in step S303 ends, the processing returns to step S301 and the processing in step S301 and subsequent steps is repeated. That is, the processing in steps S301 to S303 is repeated, so that the reception period for interruptive utterance is sequentially set according to the speed of utterance of the user.

Then, the reception period for interruptive utterance set here is used as a determination condition of the above-described processing in step S101 in FIG. 9 and the processing in step S201 in FIG. 10. For example, the speed of utterance differs for each user, such as a user who speaks slowly and a user who speaks quickly. By setting the reception period for interruptive utterance according to the speed of utterance of the user, an interruptive utterance uttered by various users can be handled.

Note that, here, the case of setting the reception period for interruptive utterance according to the speed of utterance of the user has been exemplified. However, the reception period for interruptive utterance may be set on the basis of another parameter.

A flow of the reception period setting processing has been described.

### 2. Modification

In the above-described description, in the voice interaction system 1, a configuration in which the camera 101, the microphone 102, the display device 110, and the speaker 111 are incorporated in the local-side terminal device 10, and the user recognition unit 103 to the utterance generation unit 109 are incorporated in the cloud-side server 20 has been described as an example. However, each of the camera 101 to the speaker 111 may be incorporated in either the terminal device 10 or the server 20.

For example, all of the camera 101 to the speaker 111 may be incorporated in the terminal device 10 side, and the processing may be completed on the local side. Note that, even in the case of adopting such a configuration, the database such as the user DB 131 can be managed by the server 20 on the Internet 30.

Furthermore, for the voice recognition processing performed by the voice recognition unit 104 and the semantic analysis processing performed by the semantic analysis unit 105, a voice recognition service and a semantic analysis service provided by other services may be used. In this case, the server 20 can obtain a result of voice recognition by sending voice data to the voice recognition service provided on the Internet 30, for example. Furthermore, the server 20 can obtain a result (Intent and Entity) of semantic analysis by sending data (text data) of a result of voice recognition to the semantic analysis service provided on the Internet 30, for example.

Note that the above description has been made such that the intention (Intent) and the entity information (Entity) are obtained as a result of semantic analysis in the semantic analysis processing. However, that is an example, and another piece of information may be used as long as the information expresses a meaning (intention) of an utterance by the user.

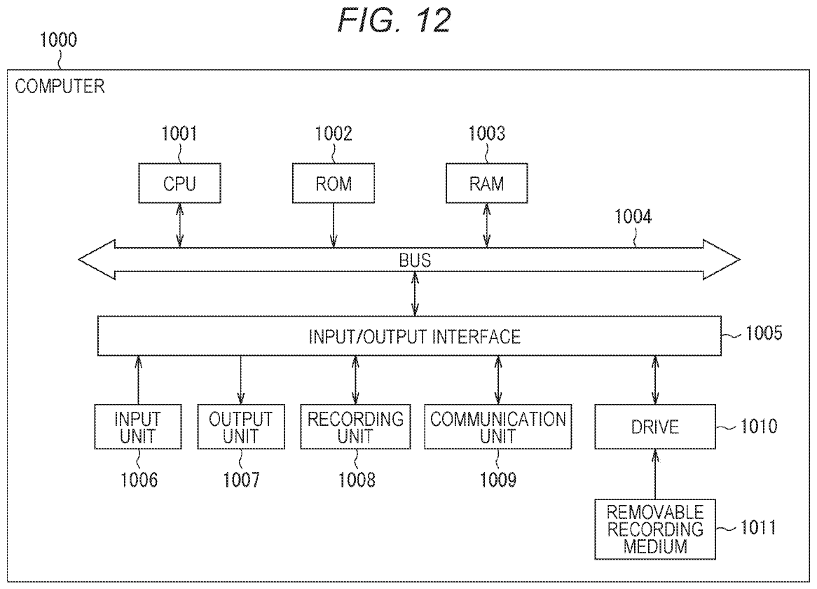

Here, the terminal device 10 and the server 20 may be configured as information processing devices including a computer 1000 in FIG. 12 to be described below.

That is, the user recognition unit 103, the voice recognition unit 104, the semantic analysis unit 105, the request execution unit 106, the presentation method control unit 107, the display control unit 108, and the utterance generation unit 109 are implemented by, for example, a CPU of the terminal device 10 or the server 20 (for example, a CPU 1001 in FIG. 12 to be described below) executing a program recorded in a recording unit (for example, a ROM 1002, a recording unit 1008, or the like in FIG. 12 to be described below).

Furthermore, although not illustrated, each of the terminal device 10 and the server 20 includes a communication interface (I/F) (a communication unit 1009 in FIG. 12 to be described below, for example) configured by a communication interface circuit and the like to exchange data via the Internet 30. With the configuration, the terminal device 10 and the server 20 can perform communication via the Internet 30, and the server 20 side can perform processing such as the presentation method control processing on the basis of data from the terminal device 10, for example, during a user's utterance.

Moreover, in the terminal device 10, an input unit (for example, an input unit 1006 in FIG. 12 to be described below) including, for example, a button, a keyboard, and the like may be provided to obtain an operation signal according to a user's operation, or the display device 110 (for example, an output unit 1007 in FIG. 12 to be described below) may be configured as a touch panel integrated with a touch sensor to obtain an operation signal according to an operation by a user's finger or a touch pen (stylus pen).

Note that, regarding the functions of the display control unit 108 illustrated in FIG. 2, some of all the functions may be provided as functions of the terminal device 10 and remaining functions may be provided as functions of the server 20, instead of all the functions being provided as the functions of the terminal device 10 or of the server 20. For example, a rendering function, of display control functions, can be provided as a function of the local-side terminal device 10, and a display layout function, of the display control functions, can be provided as a function of the cloud-side server 20.

Furthermore, in the voice interaction system 1 illustrated in FIG. 2, the input device such as the camera 101 or the microphone 102 is not limited to the terminal device 10 configured as a dedicated terminal or the like but also another electronic device such as a mobile device (for example, a smartphone) owned by the user. Moreover, in the voice interaction system 1 illustrated in FIG. 2, the output device such as the display device 110 or the speaker 111 may also be another electronic device such as a mobile device (for example, a smartphone) owned by the user.

Moreover, in the voice interaction system 1 illustrated in FIG. 2, a configuration including the camera 101 having the image sensor has been illustrated. However, another sensor device may be provided and perform sensing of the user and surroundings of the user to acquire sensor data according to a sensing result, and the sensor data may be used in subsequent processing.

Here, examples of the sensor device include a biological sensor that detects biological information such as a breath, a pulse, a fingerprint, and an iris, a magnetic sensor that detects the magnitude and direction of a magnetic field (magnetic field), an acceleration sensor that detects acceleration, a gyro sensor that detects an angle (posture), an angular velocity, and angular acceleration, a proximity sensor that detects an approaching object, and the like.

Furthermore, the sensor device may be an electroencephalogram sensor attached to the head of the user and measuring a potential or the like to detect an electroencephalogram. Moreover, the sensor device can include sensors for measuring a surrounding environment such as a temperature sensor that detects temperature, a humidity sensor that detects humidity, and an ambient light sensor that measures brightness of surroundings, and a sensor for detecting positional information such as a global positioning system (GPS) signal.

Note that, in the above description, a case in which the preceding user utterance and the subsequent user utterance (interruptive utterance) are successively performed has been described. However, the number of interruptive utterances is not limited to one, and in a case where two or more interruptive utterances are performed, the above-described present technology can be applied. That is, in a case where two interruptive utterances are made by the same or different users as the subsequent user utterances with respect to the preceding user utterance, for example, if intentions of these three utterances are equivalent, the three utterances are integrated into one by the above-described first presentation method, and a result of execution of the request corresponding processing according to the request of the integrated utterance is only required to be presented.

### 3. Configuration of Computer

The above-described series of processing (for example, the execution result presentation processing illustrated in FIG. 9 or 10) can be executed by hardware or can be executed by software. In the case of executing the series of processing by software, a program that configures the software is installed in a computer of each device. FIG. 12 is a block diagram illustrating a configuration example of hardware of a computer that executes the above-described series of processing by a program.

In a computer 1000, a central processing unit (CPU) 1001, a read only memory (ROM) 1002, and a random access memory (RAM) 1003 are mutually connected by a bus 1004. Moreover, an input/output interface 1005 is connected to the bus 1004. An input unit 1006, an output unit 1007, a recording unit 1008, a communication unit 1009, and a drive 1010 are connected to the input/output interface 1005.

The input unit 1006 includes a microphone, a keyboard, a mouse, and the like. The output unit 1007 includes a speaker, a display, and the like. The recording unit 1008 includes a hard disk, a nonvolatile memory, and the like. The communication unit 1009 includes a network interface and the like. The drive 1010 drives a removable recording medium 1011 such as a magnetic disk, an optical disk, a magneto-optical disk, or a semiconductor memory.

In the computer 1000 configured as described above, the CPU 1001 loads the program recorded in the ROM 1002 or the recording unit 1008 to the RAM 1003 via the input/output interface 1005 and the bus 1004 and executes the program, so that the above-described series of processing is performed.

The program to be executed by the computer 1000 (CPU 1001) can be recorded on the removable recording medium 1011 as a package medium or the like, for example, and can be provided. Furthermore, the program can be provided via a wired or wireless transmission medium such as a local area network, the Internet, or digital satellite broadcasting.

In the computer 1000, the program can be installed to the recording unit 1008 via the input/output interface 1005 by attaching the removable recording medium 1011 to the drive 1010. Furthermore, the program can be received by the communication unit 1009 via a wired or wireless transmission medium and installed in the recording unit 1008. Other than the above method, the program can be installed in the ROM 1002 or the recording unit 1008 in advance.

Here, in the present specification, the processing performed by the computer in accordance with the program does not necessarily have to be performed in chronological order in accordance with the order described as the flowchart. In other words, the processing performed by the computer according to the program also includes processing executed in parallel or individually (for example, parallel processing or processing by an object). Furthermore, the program may be processed by one computer (processor) or distributed in and processed by a plurality of computers.

Note that embodiments of the present technology are not limited to the above-described embodiments, and various modifications can be made without departing from the gist of the present technology.

Furthermore, the steps of the execution result presentation processing illustrated in FIG. 9 or 10 can be executed by one device or can be shared and executed by a plurality of devices. Furthermore, in the case where a plurality of processes is included in one step, the plurality of processes included in the one step can be executed by one device or can be shared and executed by a plurality of devices.

Note that the present technology can employ the following configurations.

(1)

An information processing device including:

a control unit configured to control presentation of a response to a first utterance by a user on the basis of content of a second utterance that is temporally later than the first utterance.

(2)

The information processing device according to (1), in which

the control unit presents, as the response, a result of execution based on a request of the user, the request being specified by a relationship between content of the first utterance and the content of the second utterance.

(3)

The information processing device according to (2), in which,

in a case where an intention of the first utterance and an intention of the second utterance are substantially same, the control unit presents a result of execution based on a request obtained by integrating the intention of the first utterance and the intention of the second utterance.

(4)

The information processing device according to (2), in which,

in a case where addition to the content of the first utterance has been made by the content of the second utterance, the control unit presents a result of execution based on a request obtained by adding the content of the second utterance to the content of the first utterance.

(5)

The information processing device according to (2), in which,

in a case where a part of the content of the first utterance has been changed by the content of the second utterance, the control unit presents a result of execution based on a request obtained by changing the part of the content of the first utterance by the content of the second utterance.

(6)

The information processing device according to (2), in which,

in a case where an intention of the first utterance and an intention of the second utterance are different, the control unit presents each of a result of first execution based on a first request obtained from the content of the first utterance and a result of second execution based on a second request obtained from the content of the second utterance.

(7)

The information processing device according to (2), in which,

in a case where the content of the second utterance is not for a system, the control unit presents a result of execution based on a request obtained from the content of the first utterance.

(8)

The information processing device according to (3), in which,

in a case where first processing for the first utterance is already being executed or a result of execution of the first processing is being presented, the control unit presents only the result of execution of the first processing.

(9)

The information processing device according to (4), in which,

in a case where first processing for the first utterance is already being executed or a result of execution of the first processing is being presented, the control unit presents a result of execution of second processing for the second utterance following the presentation of the result of execution of the first processing.

(10)

The information processing device according to (5), in which,

in a case where first processing for the first utterance is already being executed or a result of execution of the first processing is being presented, the control unit stops the presentation of the result of execution of the first processing or waits completion of the presentation, and presents a result of execution of second processing for the second utterance.

(11)

The information processing device according to any one of (1) to (10), in which

the first utterance is made by a first user, and

the second utterance is made by a second user different from the first user.

(12)

The information processing device according to (11), in which

the control unit presents the result of execution on the basis of user information including a characteristic of each user.

(13)

The information processing device according to (12), in which,

in a case where the content of the first utterance and the content of the second utterance are conflicted requests, the control unit selects either one of the requests on the basis of past history information, and presents a result of execution based on the request.

(14)

The information processing device according to any one of (2) to (13), in which

the control unit presents the result of execution by at least one presentation unit of a first presentation unit or a second presentation unit.

(15)

The information processing device according to (14), in which

the first presentation unit and the second presentation unit are provided in a same device or in different devices.

(16)

The information processing device according to (14) or (15), in which

the first presentation unit is a display device, and

the second presentation unit is a speaker.

(17)

The information processing device according to any one of (2) to (16), in which

the second utterance is made in a predetermined period after the first utterance is made and according to a speed of an utterance of the user.

(18)

The information processing device according to any one of (2) to (17), further including:

an execution unit configured to execute predetermined processing according to the request of the user, in which

the control unit presents a result of execution of the predetermined processing executed by the execution unit as the response.

(19)

The information processing device according to any one of (2) to (18), further including:

a voice recognition unit configured to perform voice recognition processing on the basis of voice data of an utterance of the user; and

a semantic analysis unit configured to perform semantic analysis processing on the basis of a result of voice recognition obtained in the voice recognition processing.

(20)

An information processing method of an information processing device, including:

by the information processing device, controlling presentation of a response to a first utterance by a user on the basis of content of a second utterance that is temporally later than the first utterance.

### REFERENCE SIGNS LIST

1 Voice interaction system
10 Terminal device
20 Server
30 Internet
101 Camera
102 Microphone
103 User recognition unit
104 Voice recognition unit
105 Semantic analysis unit
106 Request execution unit
107 Presentation method control unit
108 Display control unit
109 Utterance generation unit
110 Display device
111 Speaker
131 User DB
1000 Computer
1001 CPU

1. An information processing device comprising:
a control unit configured to control presentation of a response to a first utterance by a user on a basis of content of a second utterance that is temporally later than the first utterance.

2. The information processing device according to claim 1, wherein
the control unit presents, as the response, a result of execution based on a request of the user, the request being specified by a relationship between content of the first utterance and the content of the second utterance.

3. The information processing device according to claim 2, wherein,
in a case where an intention of the first utterance and an intention of the second utterance are substantially same, the control unit presents a result of execution based on a request obtained by integrating the intention of the first utterance and the intention of the second utterance.

4. The information processing device according to claim 2, wherein,
in a case where addition to the content of the first utterance has been made according to the content of the second utterance, the control unit presents a result of execution based on a request obtained by adding the content of the second utterance to the content of the first utterance.

5. The information processing device according to claim 2, wherein,
in a case where a part of the content of the first utterance has been changed according to the content of the second utterance, the control unit presents a result of execution based on a request obtained by changing the part of the content of the first utterance according to the content of the second utterance.

6. The information processing device according to claim 2, wherein,
in a case where an intention of the first utterance and an intention of the second utterance are different, the control unit presents each of a result of first execution based on a first request obtained from the content of the first utterance and a result of second execution based on a second request obtained from the content of the second utterance.

7. The information processing device according to claim 2, wherein,
in a case where the content of the second utterance is not for a system, the control unit presents a result of execution based on a request obtained from the content of the first utterance.

8. The information processing device according to claim 3, wherein,
in a case where first processing for the first utterance is already being executed or a result of execution of the first processing is being presented, the control unit presents only the result of execution of the first processing.

9. The information processing device according to claim 4, wherein,
in a case where first processing for the first utterance is already being executed or a result of execution of the first processing is being presented, the control unit presents a result of execution of second processing for the second utterance following the presentation of the result of execution of the first processing.

10. The information processing device according to claim 5, wherein,
in a case where first processing for the first utterance is already being executed or a result of execution of the first processing is being presented, the control unit stops the presentation of the result of execution of the first processing or waits completion of the presentation, and presents a result of execution of second processing for the second utterance.

11. The information processing device according to claim 2, wherein
the first utterance is made by a first user, and
the second utterance is made by a second user different from the first user.

12. The information processing device according to claim 11, wherein
the control unit presents the result of execution on a basis of user information including a characteristic of each user.

13. The information processing device according to claim 12, wherein,
in a case where the content of the first utterance and the content of the second utterance are conflicted requests, the control unit selects either one of the requests on a basis of past history information, and presents a result of execution based on the request.

14. The information processing device according to claim 2, wherein
the control unit presents the result of execution by at least one presentation unit of a first presentation unit or a second presentation unit.

15. The information processing device according to claim 14, wherein
the first presentation unit and the second presentation unit are provided in a same device or in different devices.

16. The information processing device according to claim 15, wherein
the first presentation unit is a display device, and
the second presentation unit is a speaker.

17. The information processing device according to claim 2, wherein
the second utterance is made in a predetermined period after the first utterance is made and according to a speed of an utterance of the user.

18. The information processing device according to claim 2, further comprising:
an execution unit configured to execute predetermined processing according to the request of the user, wherein
the control unit presents a result of execution of the predetermined processing executed by the execution unit as the response.

19. The information processing device according to claim 18, further comprising:
a voice recognition unit configured to perform voice recognition processing on a basis of voice data of an utterance of the user; and
a semantic analysis unit configured to perform semantic analysis processing on a basis of a result of voice recognition obtained in the voice recognition processing.

20. An information processing method of an information processing device, comprising:
by the information processing device, controlling presentation of a response to a first utterance by a user on a basis of content of a second utterance that is temporally later than the first utterance.
